(19) United States
(12) Patent Application Publication
(10) Pub. No.: US 2025/0325911 A1
(43) Pub. Date: Oct. 23, 2025

(54) NON-TRANSITORY COMPUTER-READABLE STORAGE MEDIUM HAVING GAME PROGRAM STORED THEREIN, GAME APPARATUS, AND GAME PROCESSING METHOD

(71) Applicant: Nintendo Co., Ltd., Kyoto (JP)

(72) Inventors: Misaki HIRAGA, Kyoto (JP); Rina WEGNER, Tokyo (JP); Takuya FUJIMOTO, Tokyo (JP); Yumika SAITO, Tokyo (JP)

(21) Appl. No.: 19/061,481

(22) Filed: Feb. 24, 2025

(30) Foreign Application Priority Data
Apr. 23, 2024 (JP) 2024- 69753

(51) Int. Cl. A63F 13/537; A63F 13/45; A63F 13/69; A63F 13/822

(52) U.S. Cl. CPC A63F 13/537; A63F 13/45; A63F 13/69; A63F 13/822; A63F 2300/308; A63F 2300/638

(57) ABSTRACT

A UI including at least a plurality of player indicators respectively corresponding to players is updated in accordance with progress of a game such that the player indicator corresponding to a player of a currently played turn or a next turn is placed at a first position and the player indicators corresponding to the players whose turns arrive later are aligned in an order of arrival of turns so as to follow the first position.

### CROSS REFERENCE TO RELATED APPLICATION

This application claims priority to Japanese Patent Application No. 2024-69753 filed on Apr. 23, 2024, the entire contents of which are incorporated herein by reference.

### FIELD

The present disclosure relates to information processing for games, etc.

### BACKGROUND AND SUMMARY

Hitherto, there have been multiplayer games in which player characters take turns to act in each round and finally all the player characters perform a mini-game event.

In a turn-based multiplayer game, the order of turns is important from a strategic point of view, but if players do not check carefully, the players may misunderstand this order.

Therefore, it is an object of the exemplary embodiments to provide a non-transitory computer-readable storage medium having a game program stored therein, etc., which can make it easier to understand the order of actions in a turn-based multiplayer game.

In order to attain the object described above, for example, the following configuration examples are exemplified.

A first configuration example is directed to a non-transitory computer-readable storage medium having stored therein a game program causing one or more processors of an information processing apparatus to, in a multiplayer game by a plurality of players: in each turn associated with each of the players, perform game processing, based on play by the player who is taking their turn, and cause the game to progress in accordance with an order of the turns; update a UI, including at least a plurality of player indicators respectively corresponding to the players, in accordance with progress of the game such that the player indicator corresponding to a player of a currently played turn or a next turn is placed at a first position and update the UI the player indicators corresponding to the players whose turns arrive later are aligned in an order of arrival of turns so as to follow the first position; and generate a game image including at least a game scene and the UI.

According to the above configuration example, the player who is currently taking their turn can play while clearly seeing the order of arrival of the subsequent turns of the other players, so that it becomes easier to play more strategically. In addition, the players who are not currently taking their turn can also clearly see the order of arrival of the turns of the other players, so that it becomes easier to play more strategically.

In a second configuration example based on the first configuration example, the game program further causes the one or more processors to cause the game to progress by repeating a round including a plurality of turns in a predetermined order and including at least the turns of all the players.

According to the above configuration example, in the game in which the round is repeated, the player who is currently taking their turn can play while clearly seeing the order of arrival of the subsequent turns of the other players, and the players who are not currently taking their turn can also clearly see the order of arrival of the turns of the other players, so that it becomes easier to play more strategically.

In a third configuration example based on the first or second configuration example, the game program further causes the one or more processors to: at start of each of the turns of the players, place the player indicator corresponding to the player whose turn has started, at the first position, and place a player character controlled in a virtual space based on play by said player, at a position in the virtual space, said position being associated with the first position in the game image; and control the play based on play by the player whose turn has started.

According to the above configuration example, by placing the player character at the position associated with the player indicator, it becomes easier to understand that the turn has arrived.

In a fourth configuration example based on the second or third configuration example, the turns included in the round further include a turn in which an in-game event of the game occurs, in addition to the turns of the players, the UI further includes an event indicator indicating the in-game event, in addition to the plurality of player indicators, and the game program further causes the one or more processors to: execute the in-game event if the turn for the in-game event in the round arrives in the game; and update the UI in accordance with progress of the game such that the player indicators and the event indicator corresponding to the in-game event are aligned in the order of arrival.

According to the above configuration example, the player who is currently taking their turn can play their turn while also recognizing the timing of occurrence of the event in the round, so that it becomes much easier to play strategically.

In a fifth configuration example based on the fourth configuration example, the in-game event is a mini-game event in which the plurality of players participate simultaneously, and the game program further causes the one or more processors to, at a first timing at start of the mini-game event: further update the UI such that the player indicators are arranged in an order of turns of the players after the mini-game event; and place player characters respectively controlled in a virtual space based on play by the players, at positions in the virtual space, said positions being respectively associated with positions of the player indicators in the game image.

According to the above configuration example, even at the start of the event in which the plurality of players participate simultaneously, each player can grasp the order of arrival of the subsequent turns.

In a sixth configuration example based on the fifth configuration example, the mini-game event is a competitive mini-game event in which the plurality of players are divided into a plurality of teams and compete against each other, and the game program further causes the one or more processors to, at a second timing at the start of the mini-game event and after the first timing: further update the UI such that the player indicators are placed for each team; and further move each of the player characters to a position in the virtual space, said position being associated with an updated position of the player indicator.

According to the above configuration example, even when the player characters are to be arranged for each team, the player characters are arranged in the order of arrival of the turns in advance, and are then arranged for each team, whereby it is possible to prevent the order of arrival of the turns from being misunderstood.

In a seventh configuration example based on the fifth or sixth configuration example, the game program further causes the one or more processors to, at a third timing at the start of the mini-game event and before the first timing, further update the UI such that the event indicator is placed at the first position and the player indicators are arranged in the order of turns of the players after the mini-game event.

According to the above configuration example, at the start of the mini-game event, it is possible to indicate that the turn for the mini-game event has arrived.

In an eighth configuration example based on the fifth or sixth configuration example, the game program further causes the one or more processors to, at a fourth timing at which a result of the mini-game event is displayed after end of the mini-game event: further update the UI such that the player indicators are arranged in the order of turns of the players after the mini-game event; and place each of the player characters at a position in the virtual space, said position being associated with a position of the player indicator.

According to the above configuration example, when the result is announced at the end of the game event, it is possible to indicate the order of arrival of the subsequent turns in a manner that is easy to understand and difficult to misunderstand the order.

In a ninth configuration example based on any one of the first to eighth configuration examples, the player indicators further include information regarding scores of the respective players in the game.

According to the above configuration example, each player can play while taking into account the scores and the order of arrival of the turns.

In a tenth configuration example based on any one of the first to ninth configuration examples, the player indicators further include images of the player characters controlled based on play by the respective players in the game.

According to the above configuration example, each player can recognize their own player indicator at a glance.

In an eleventh configuration example based on any one of the first to tenth configuration examples, the player indicators further include images of the respective players.

According to the above configuration example, each player can recognize their own player indicator at a glance.

In a twelfth configuration example based on any one of the first to eleventh configuration examples, the player indicators further include names assigned to the respective players.

According to the above configuration example, each player can recognize their own player indicator at a glance.

According to the exemplary embodiments, it is possible to provide a non-transitory computer-readable storage medium having a game program stored therein, etc., which can make it easier to understand the order of actions in a turn-based multiplayer game.

### BRIEF DESCRIPTION OF THE DRAWINGS

FIG. 1 is a block diagram showing a non-limiting example of the internal configuration of a game apparatus 1, etc.;

FIG. 2 illustrates a non-limiting example of a game screen (game board);

FIG. 3 illustrates a non-limiting example of the game screen;

FIG. 4 illustrates a non-limiting example of the game screen;

FIG. 5 illustrates a non-limiting example of the game screen;

FIG. 6 illustrates a non-limiting example of the game screen;

FIG. 7 illustrates a non-limiting example of the game screen;

FIG. 8 illustrates a non-limiting example of a game screen (competitive mini-game);

FIG. 9 illustrates a non-limiting example of the game screen (competitive mini-game);

FIG. 10 illustrates a non-limiting example of the game screen (competitive mini-game);

FIG. 11 illustrates a non-limiting example of the game screen (competitive mini-game);

FIG. 12 illustrates a non-limiting example of the game screen (competitive mini-game);

FIG. 13 illustrates a non-limiting example of the game screen (competitive mini-game);

FIG. 14 illustrates a non-limiting example of the game screen (competitive mini-game);

FIG. 15 illustrates a non-limiting example of the game screen (competitive mini-game);

FIG. 16 shows a non-limiting example of various types of data stored in a storage section 12; and

FIG. 17 is a non-limiting example of a flowchart of game processing.

### DETAILED DESCRIPTION OF NON-LIMITING EXAMPLE EMBODIMENTS

Hereinafter, one exemplary embodiment will be described.

### Hardware Configuration of Information Processing Apparatus

First, an information processing apparatus (information processing system) for executing information processing according to the exemplary embodiment will be described. The information processing apparatus is, for example, a smartphone, a stationary or hand-held game apparatus, a tablet terminal, a personal computer, a wearable terminal, or the like. The information processing according to the exemplary embodiment can also be applied to a game system including a game apparatus, etc., as described above, and a predetermined server. In the exemplary embodiment, a stationary game apparatus (hereinafter referred to simply as “game apparatus”) is described as an example of the information processing apparatus.

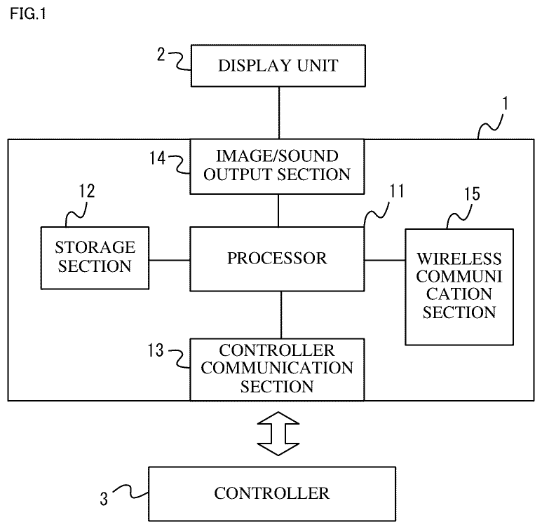

FIG. 1 is a block diagram showing an example of the internal configuration of a game apparatus 1 according to the exemplary embodiment. The game apparatus 1 includes a processor 11. The processor 11 is an information processing section for executing various types of information processing to be executed by the game apparatus 1. For example, the processor 11 may be composed only of a CPU (Central Processing Unit), or may be composed of a SoC (System-on-a-chip) having a plurality of functions such as a CPU function and a GPU (Graphics Processing Unit) function. The processor 11 may be composed of one processor, or may be composed of a plurality of processors. The processor 11 performs various types of information processing by executing an information processing program (e.g., a game program) stored in a storage section 12. The storage section 12 may be, for example, an internal storage medium such as a flash memory or a DRAM (Dynamic Random Access Memory), or may be configured to utilize an external storage medium mounted to a slot that is not shown, or the like.

The game apparatus 1 further includes a wireless communication section 15 for allowing the game apparatus 1 to perform wireless communication with another game apparatus 1 or a predetermined server device. Examples of the wireless communication include Internet communication and short-range wireless communication.

The game apparatus 1 further includes a controller communication section 13 for allowing the game apparatus 1 to perform wired or wireless communication with a controller 3.

A display unit 2 (e.g., a television, a display, or the like) is connected to the game apparatus 1 via an image/sound output section 14. The processor 11 outputs images and sounds generated (by execution of the above-described information processing, for example), to the display unit 2 via the image/sound output section 14.

Next, the controller 3 will be described. Although not shown, the controller 3 of the exemplary embodiment has a housing having a vertically long shape as an example, and can be held in the orientation in which the housing is vertically long. The housing has a shape and a size that allow the housing to be held with one hand when the housing is held in the orientation in which the housing is vertically long. The housing can be held in the orientation in which the housing is horizontally long, and in this case, the housing can be held and operated with both hands.

The controller 3 includes at least one analog stick (not shown) being an example of a direction input device. The analog stick can be used as a direction input section with which a direction can be input. A user tilts the analog stick and thereby can input a direction corresponding to the direction of the tilt (and input a magnitude corresponding to the angle of the tilt). The controller 3 further includes a button section (not shown) including various operation buttons. For example, the controller 3 may include a plurality of operation buttons on a main surface of the housing.

The controller 3 also includes a communication section (not shown) for performing wired or wireless communication with the controller communication section 13. The content of a direction input to the analog stick, information indicating the pressed state of the button section, etc., are repeatedly transmitted to the game apparatus 1 via the communication section at appropriate timings.

In addition, up to four controllers 3 can be connected to the game apparatus 1, and the game apparatus 1 can also be connected to another game apparatus 1 via the wireless communication section 15. Then, a multiplayer game can be played using the game apparatus 1 by up to four users.

### Game Assumed in Exemplary Embodiment

Next, an outline of game processing (an example of information processing) to be executed in the game apparatus 1 according to the exemplary embodiment will be described. First, the game assumed in the exemplary embodiment is a multiplayer game based on the motif of “Sugoroku (Japanese board game similar to backgammon)” in which a plurality of players take turns to roll a die and move their own pieces forward on a game board (sometimes simply referred to as “board”) by the number of squares corresponding to the number obtained by rolling the die. In this game, up to four players (users) can play. Instead of a user, the processor 11 (see FIG. 1) of the game apparatus 1 can also be allowed to function as a player and participate in this game. In the following, a description will be given with the case where this game is played by four players (first player, second player, third player, fourth player) as an example.

### Details of Game Processing of Exemplary Embodiment

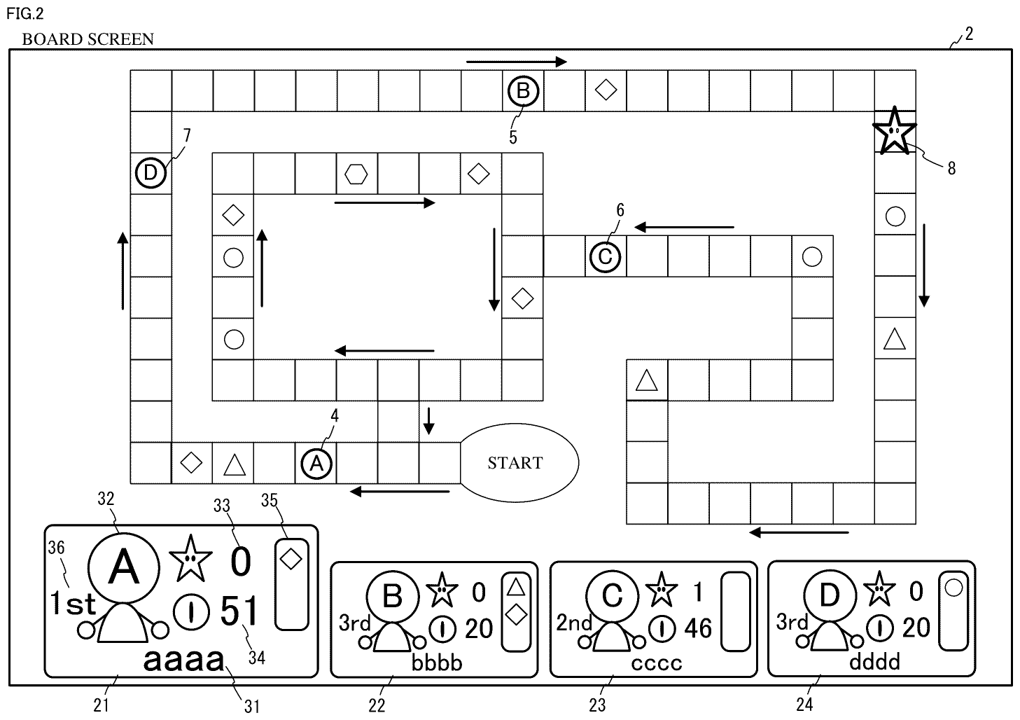

FIG. 2 illustrates an example of a board screen of this game. As shown FIG. 2, the overall image of a Sugoroku route (sometimes simply referred to as “route”) composed of many squares is displayed on the board screen, and the board screen serves as a map. On some of the squares of the route, an icon 4 indicating a player character (sometimes simply referred to as “character”) A operated by the first player, an icon 5 indicating a player character B operated by the second player, an icon 6 indicating a player character C operated by the third player, and an icon 7 indicating a player character D operated by the fourth player, are displayed. At the start of this game, each player selects a character to be operated by the player from among many characters, but each player cannot select a character that has already been selected by another player. That is, in this game, multiple players cannot select the same character and operate this character as their own character.

As shown FIG. 2, the route has a start point labeled with “Start”, and the game progresses as the characters A to D start moving forward from the start point. Hereinafter, specific description will be given. In this game, each character rolls a die in accordance with an operation by the player in a predetermined turn order, and moves forward by the number of squares corresponding to the number obtained by rolling the die. The turn order is an order determined at the start of this game, for example, as the order of the magnitudes of the numbers obtained by the respective players performing an operation for rolling the die. In FIG. 2, each arrow displayed on the route indicates a direction in which each character can move. At junctions on the route, each character moves in a direction corresponding to an operation by the player. The board screen can be displayed by each player performing a predetermined operation during their own turn.

In addition, depending on the square to which a character has moved forward, this character may obtain an advantage or a disadvantage. There are many types of squares, and, for example, if a character advances to (or stops at) a certain square, a predetermined number of coins are given to this character. For example, at a certain square, 10 coins are given, and at another certain square, 5 coins are given. Also, if a character advances to a certain square, this character loses a predetermined number of coins. Also, for example, if a character advances to a certain square, this character is returned to the start point. Furthermore, there are also squares at each of which neither an advantage nor a disadvantage is given to a character even if this character advances to this square. Also, although not shown in FIG. 2, there are squares in each of which whether or not to give an advantage or a disadvantage is displayed, and there are squares in each of which whether or not to give an advantage or a disadvantage is not displayed.

In addition, some squares have items placed thereon, and if a character advances to a square having an item placed thereon, this character acquires the item. There are multiple types of items, and, for example, there are items that take a predetermined number of coins, for example, 10 coins or 20 coins, from among the coins owned by any other character. Also, there are items that reduce the number obtained by any other character rolling the die, thereby hindering the advancement of this character, items that double the number obtained by the own character rolling the die, thereby increasing the speed of advancement of the own character, etc. In FIG. 2, triangular items, square items, and circular items are placed on the route.

Each player causes their own character to roll the die according to the turn order described above, advance on the route, and reach a square having a star 8 placed thereon. A character (player) who reaches the square having the star 8 placed thereon can acquire the star 8 in exchange for a predetermined number of coins, for example, 20 coins. That is, if the character owns 20 or more coins, the character can acquire the star 8. Only one star 8 is placed at a time, and if a character acquires the star 8, the next star 8 is placed on another square.

In this game, if a round including one turn for each of the characters A to D is completed a specified number of times, for example, 10 times, the game ends. In another example, the specified number of times may be another number such as 15 times, 20 times, and 30 times. Then, the character (player) who has acquired the largest number of stars 8 at the end of the game is a winner. This means that it important to have a strategy in order to cause the own character to acquire stars 8 while hindering other characters from acquiring stars 8. For example, it is assumed that, when there is another character who is closer to a star 8 than the own character, the other character owns 20 coins with which the star 8 can be acquired. In this case, if the own character owns an item that takes coins, a strategy to use this item to take the coins of the other character, thereby hindering the other character from acquiring the star 8, is conceivable. Also, in this case, if the own character owns an item that reduces the number obtained by another character rolling the die, a strategy to use this item to reduce the number of squares by which the other character advances, thereby hindering the other character from acquiring the star 8, is conceivable. However, in order to think of such a strategy, the order of arrival of the turn, the number of owned stars 8, the number of owned coins, owned items, etc., for each character are important.

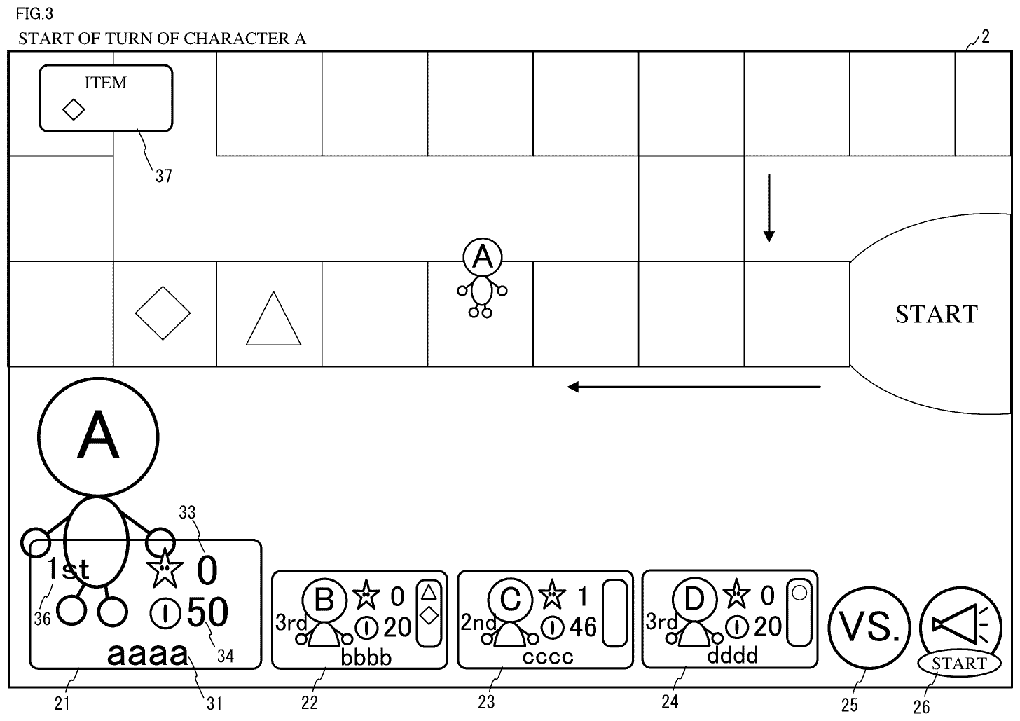

Therefore, in the exemplary embodiment, a turn display UI (user interface) including a player indicator corresponding to each player is displayed in the lower area of a screen such that this information can be seen at a glance. The turn display UI is displayed on the board screen (FIG. 2), on a screen during game progress (FIG. 3, etc.), during a mini-game (FIG. 8 to FIG. 14, etc.), etc.

As shown in FIG. 2, the turn display UI includes a player indicator 21 corresponding to the first player, a player indicator 22 corresponding to the second player, a player indicator 23 corresponding to the third player, and a player indicator 24 corresponding to the fourth player. In addition, the turn display UI is displayed such that the player indicators 21 to 24 are aligned from the left in the order of arrival of turns. As will be described later, as turns, there are also event turns corresponding to event indicators indicating execution of events (in-game events) such as mini-games, and such an event indicator is also displayed so as to be aligned from the left in the order of arrival of turns (see FIG. 3). Also, as will be described later, there are exceptional cases where the player indicators are not displayed so as to be aligned from the left in the order of arrival of turns (see FIG. 10).

The player indicators 21 to 24 each include a player name display 31 indicating a name assigned to the player, a character image 32, an acquired star count display 33 indicating the number of acquired stars, an owned coin count display 34 indicating the number of owned coins, an owned item display 35 indicating owned items, and an owned coin ranking display 36 indicating the ranking of the number of owned coins. For example, at the start of this game, each player can set their own name or the like as a player name, and the set player name is displayed as the player name display 31. Also, for example, at the start of this game, if each player has an account, each player can set the account name as a player name. However, the method for setting a player name is not limited to the above. The character image 32 is an image of the character, and is not the character itself operated by the player in a virtual space. Also, as will be described later, the display contents, etc., of the player indicators 21 to 24 may change depending on the situation (see FIG. 3, FIG. 9, etc.). In addition, the acquired star count display 33, the owned coin count display 34, and the owned coin ranking display 36 are information regarding scores.

By displaying the player indicators of all the players in the lower part of the screen such that the player indicators are aligned in the order of arrival of turns as described above, each player is allowed to confirm at a glance the order of arrival of turns for all the players and other information necessary for strategy while the board screen is displayed.

Next, the start of a turn of a character will be described. FIG. 3 illustrates the start of a turn of the character A operated by the first player. As shown in FIG. 3, the character A on the route is displayed when the turn of the character A starts. In addition, the player indicator 21 of the first player is displayed at the left end of the turn display UI in an enlarged manner. Also, the owned item display and the character image are hidden in the player indicator 21 (see FIG. 2). Instead of the owned item display being hidden, a display 37 indicating items owned by the character A is shown at the upper left of the screen. In addition, instead of the character image being hidden, the character A is displayed behind the player indicator 21. As shown in FIG. 3, the player indicators 21 to 24 have translucent portions, so that the overall image of the character A is visible. The character A does not have to be displayed behind the player indicator 21, and may be displayed at another position as long as this position is associated with the player indicator 21.

By displaying the turn display UI such that the player indicators and the event indicators are aligned in the order of arrival of turns as described above, each player is allowed to confirm at a glance the order of turns for all the players and other information necessary for strategy. In addition, since the character A is displayed at the position associated with the player indicator 21, it is possible to recognize at a glance that it is a turn for the first player who operates the character A.

In FIG. 3, an event indicator 25 indicating execution of a competitive mini-game is displayed next to the player indicator 24, and an event indicator 26 indicating the start of a time sale is displayed next to the event indicator 25. In the exemplary embodiment, turns of the first player to the fourth player are executed, and a turn for a competitive mini-game in which all the players participate is executed, whereby one round ends. In addition, a round may include a turn for the start of the time sale as the first turn, and a turn for the end of the time sale as the final turn. During the time sale, for example, if a character stops at a square where an item can be purchased with coins, this character can purchase the item with fewer coins than usual. In FIG. 3, the event indicator 26 for the start of the time sale is displayed as an indicator for the first turn of the next round.

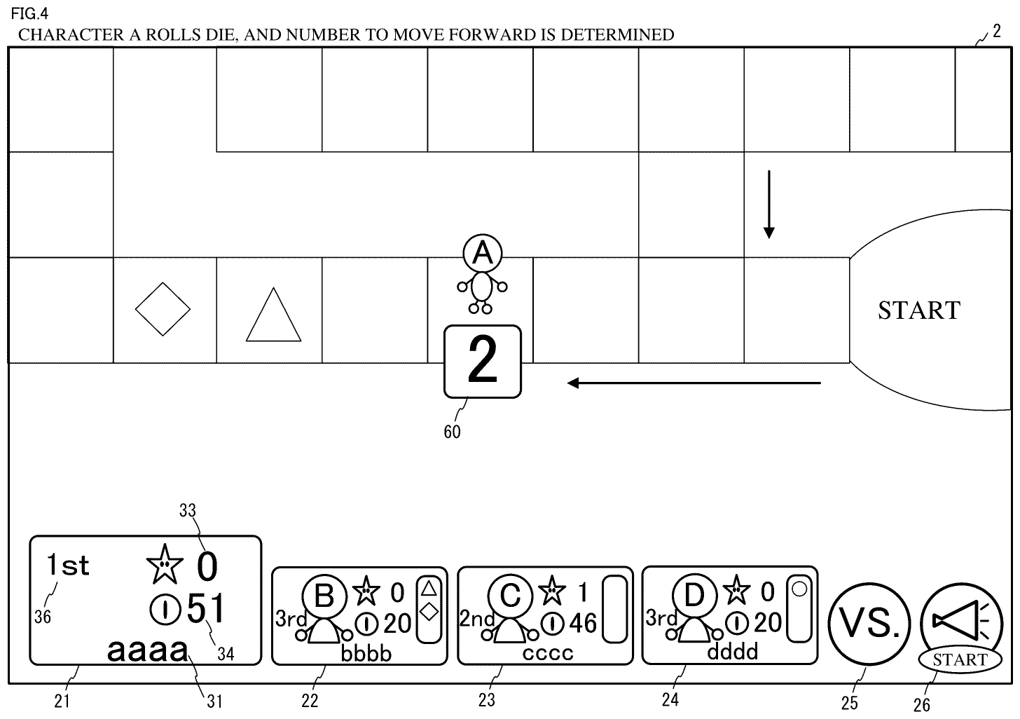

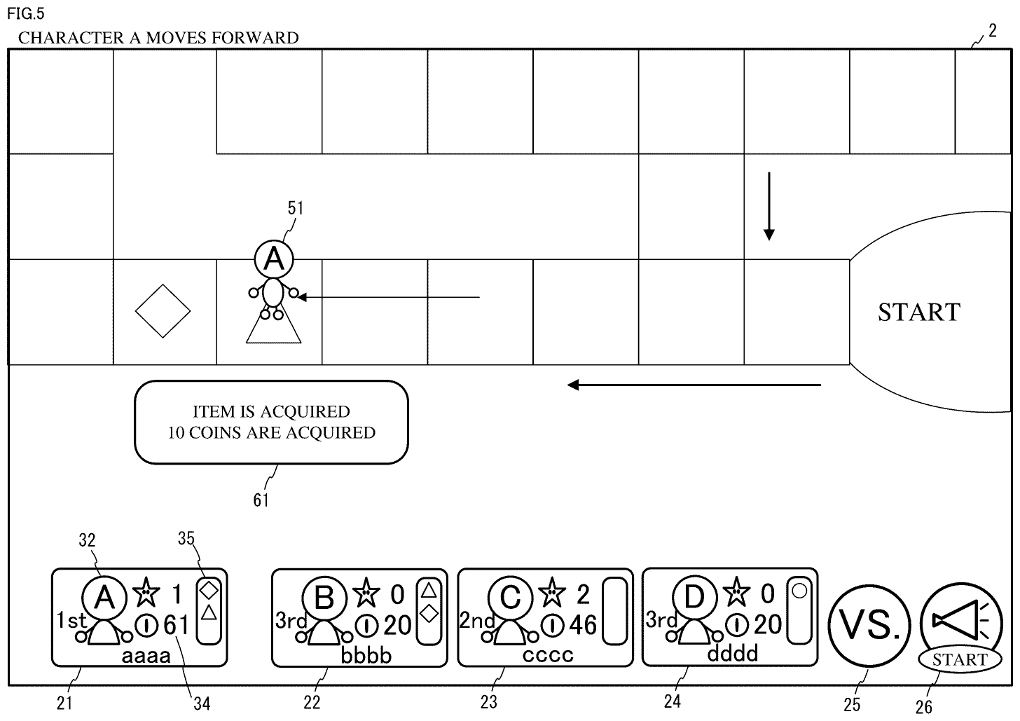

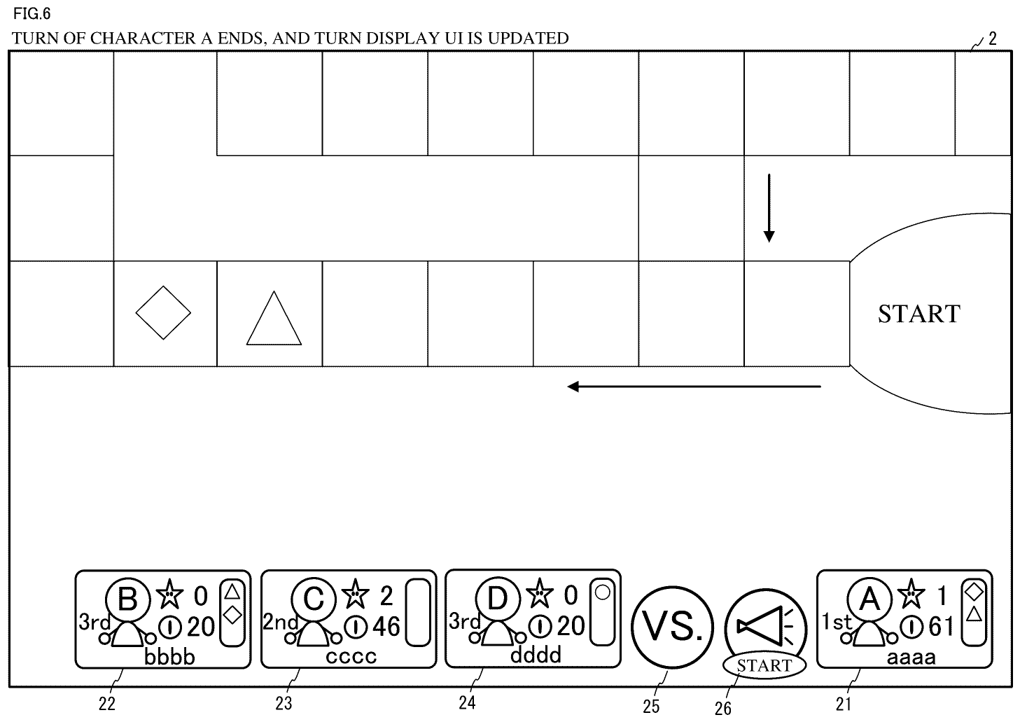

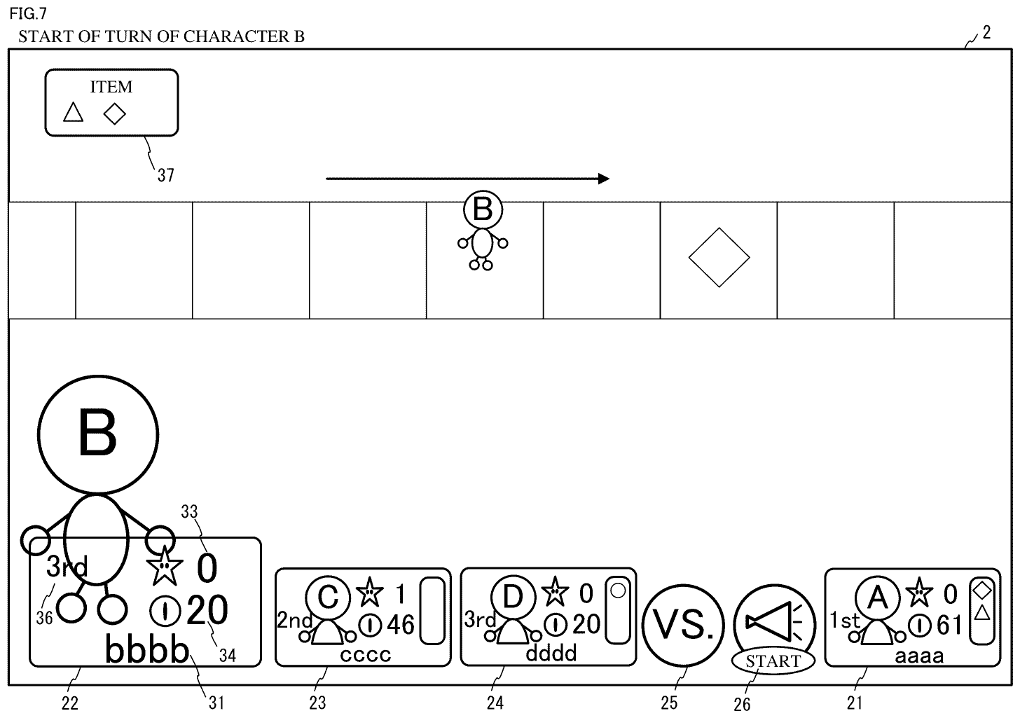

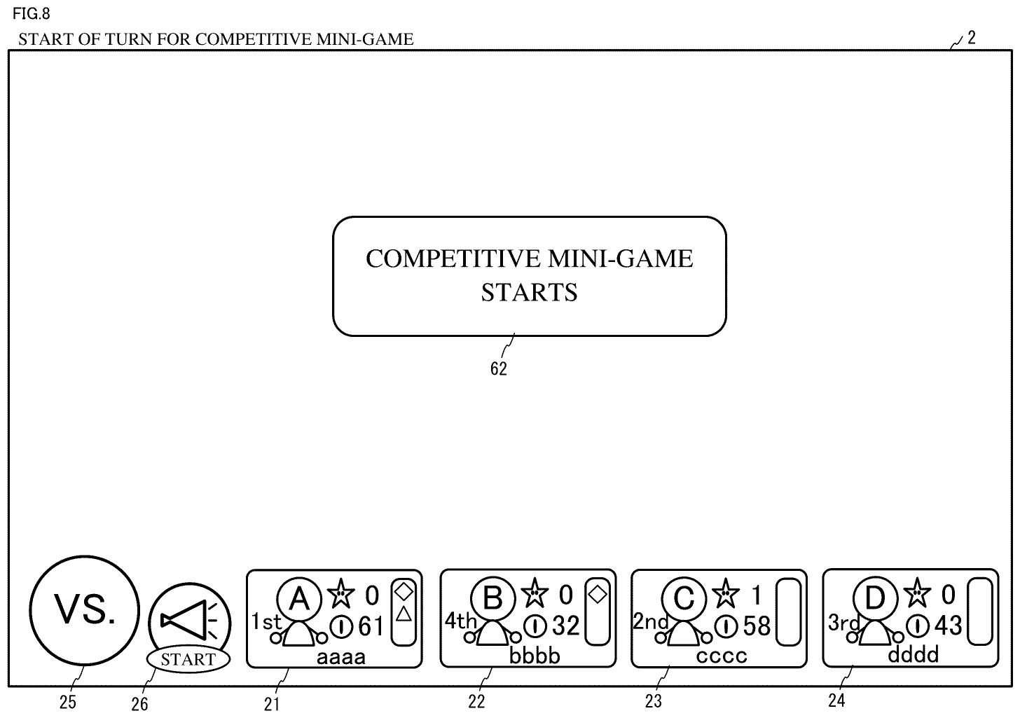

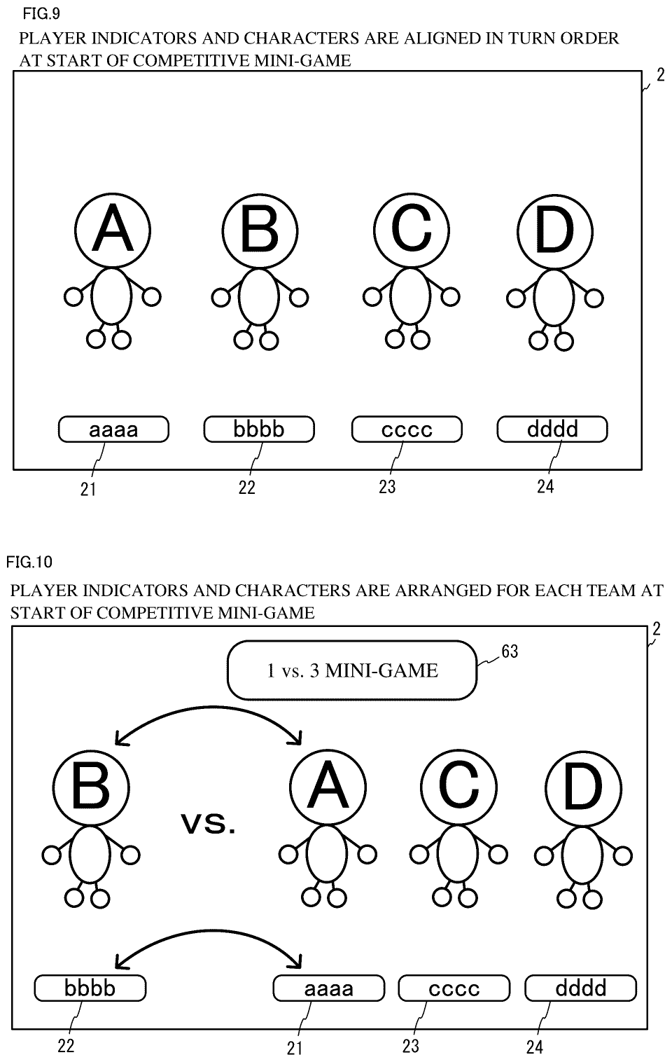

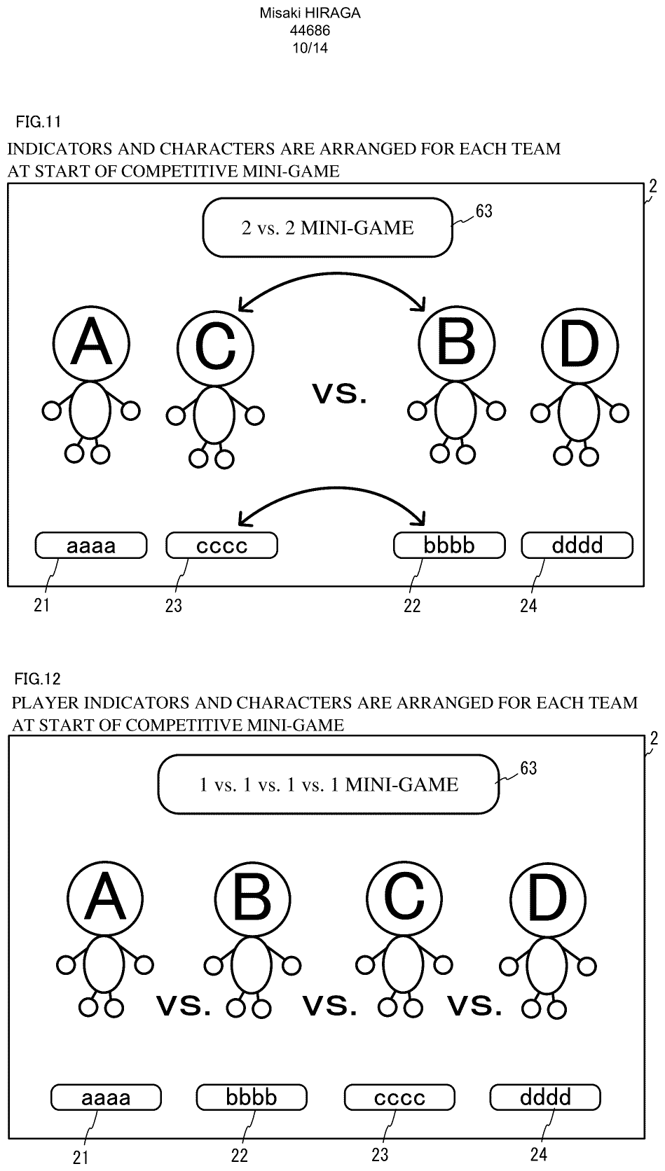

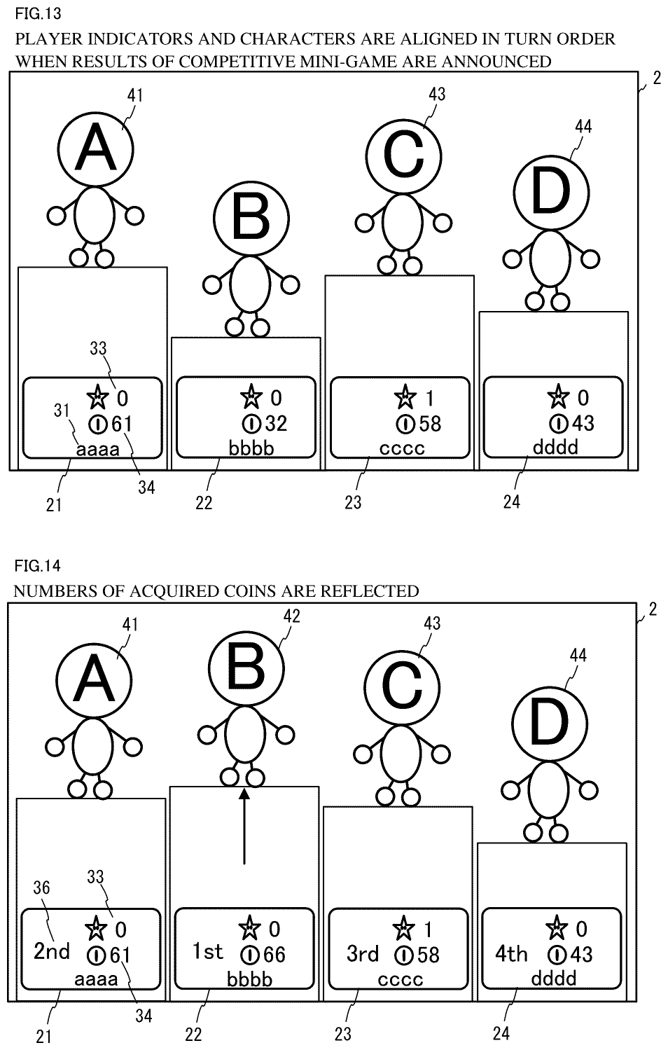

Next, a scene where a character rolls the die and the number of squares by which the character advances is determined, will be described. FIG. 4 shows a scene that follows the scene in FIG. 3 and in which the character A rolls a die 60 in accordance with an operation by the first player and the die 60 stops at “2”. When the character A rolls the die 60, the display of the character A behind the player indicator 21 ends. In addition, during the own turn, the player can use an item owned by the own character by performing a predetermined operation before causing the own character to roll the die. From this, when the character A rolls the die 60, the display of the display 37 (see FIG. 3) indicating items ends.

Next, a scene where the character advances by the number of squares corresponding to the number obtained by the character rolling the die, will be described. FIG. 5 shows a scene that follows the scene in FIG. 4 and in which the character A advances by two squares and then stops in accordance with the number “2” on the stopped die 60. As shown in FIG. 5, in the scene where the advancing character stops, the same display items as for the other players are displayed in the player indicator of the player who is executing the turn. In other words, the display of the character image 32 and the owned item display 35 which have been hidden is restarted (see FIG. 5). In addition, in FIG. 5, a triangular item is placed on the stopped square, and this square is set such that 10 coins are given at the square, so that a display 61 indicating that the item and 10 coins have been acquired is performed. In addition, along with this, in the player indicator 21, the triangular item is added to the owned item display, and the owned coin count display 34 is increased by 10.

Next, a scene where the turn of the character has ended will be described. FIG. 6 shows a scene that follows the scene in FIG. 5. As shown in FIG. 6, when the turn of the character A ends, the player indicator 21 which has been displayed at the left end of the turn display UI disappears from the left end, and is displayed at the right end of the turn display UI for the next round.

FIG. 7 shows a scene that follows the scene in FIG. 6, and shows the start of the turn of the character B operated by the second player. The description of the scene in FIG. 7 is the same in content as already described with reference to FIG. 3, and thus is omitted.

Next, the start of a competitive mini-game, which is a type of event, will be described. FIG. 8 illustrates the start of a turn for a competitive mini-game. The competitive mini-game is a mini-game in which characters compete against each other, and is, for example, a mini-game in which characters race on bicycles, a mini-game in which characters try to make their opponent fall down on a slippery skating rink, or a mini-game in which characters try to acquire coins while flying through the air. As shown in FIG. 8, at the start of the turn for the competitive mini-game, the event indicator 25 indicating execution of the competitive mini-game is displayed at the left end of the turn display UI in an enlarged manner for a relatively short time (e.g., 0.5 seconds), and a display 62 indicating “Competitive mini-game starts” is displayed. This indicates that the turn for the competitive mini-game has started.

Next, a scene where characters who compete against each other are aligned at the start of the turn for the competitive mini-game, will be described. FIG. 9 shows a scene that follows the scene in FIG. 8. As shown in FIG. 9, at the start of the turn for the competitive mini-game, the player indicators 21 to 24 are displayed in the lower part of the screen so as to be aligned in the order of arrival of turns after the end of the competitive mini-game. In addition, during the competitive mini-game, in order to allow the players to focus on the competitive mini-game, the displays other than the player name display are hidden in each player indicator. In addition, the event indicator is also hidden.

Then, at the start of the turn for the competitive mini-game, the player indicators and each player move for each team to change the arrangement thereof. Examples of the competitive mini-game include a mini-game in which the players are divided into a team of three players and a team of one player and compete against each other, a mini-game in which the players are divided into teams of two players and compete against each other, and a mini-game in which each character is regarded as one team and competes against each other. If this game is played by three players, there is a case where a competitive mini-game in which the players are divided into a team of two players and a team of one player and compete against each other, is played. FIG. 10 shows a scene that follows the scene in FIG. 9 and that is a scene at the start of a turn in a competitive mini-game in which one player competes against three players. As shown in FIG. 10, at the start of a turn in the competitive mini-game in which the players are divided into a team of three players and a team of one player and compete against each other, the player indicators and each player move to positions where the players are divided into a team of three players and a team of one player, to change the arrangement thereof. In FIG. 10, the player indicator 21 and the character A are swapped with the player indicator 22 and the character B, so that these player indicators and characters move to positions where a team of three players and a team of one player are formed, to change the arrangement thereof. In addition, a display 63 indicating “1 vs. 3 mini-game” is displayed.

FIG. 11 shows a scene that follows the scene in FIG. 9 and that is a scene at the start of a turn in a competitive mini-game in which the players are divided into teams of two players and compete against each other. As shown in FIG. 11, at the start of the turn in the competitive mini-game in which the players are divided into teams of two players and compete against each other, the player indicators and each player move to positions where teams of two players are formed, to change the arrangement thereof. In FIG. 11, the player indicator 22 and the character B are swapped with the player indicator 23 and the character C such that these player indicators and characters move to positions where teams of two players are formed, to change the arrangement thereof. In addition, a display 63 indicating “2 vs. 2 mini-game” is displayed.

FIG. 12 shows a scene that follows the scene in FIG. 9 and that is a scene at the start of a turn in a competitive mini-game in which each character is regarded as one team and competes against each other. As shown in FIG. 12, at the start of the turn in this competitive mini-game, the player indicators and each player are at the same positions as in the scene in FIG. 9. In addition, a display 63 indicating “1 vs. 1 vs. 1 vs. 1 mini-game” is displayed.

Then, a competition in the competitive mini-game is started. Although the details are omitted, in the competition in the competitive mini-game, there are a case where a character can acquire coins during the competition, a case where a character that wins the competition can acquire coins, etc., and each player aims to acquire more coins.

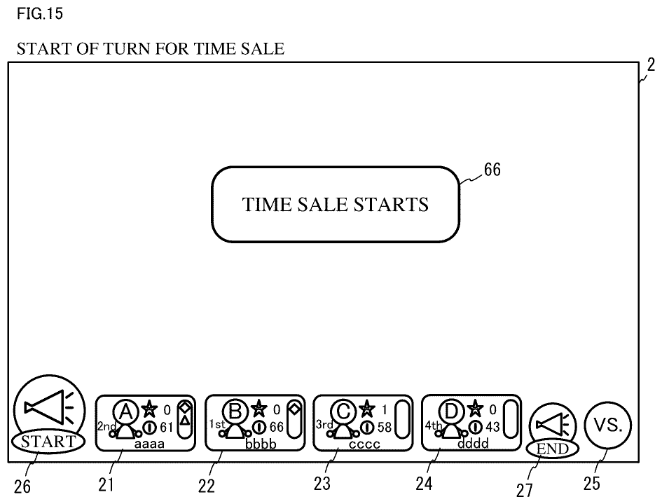

Next, a scene when the results of the competitive mini-game are announced, will be described. FIG. 13 and FIG. 14 illustrate a scene where a competition started after one of the scenes in FIG. 10 to FIG. 12 has ended and the results of the competitive mini-game are announced. First, as shown in FIG. 13, when the results of the competitive mini-game are announced, the player indicators 21 to 24 are displayed in the lower part of the screen so as to be aligned in the order of arrival of turns after the end of the competitive mini-game. At this time, the displays other than the player name display 31, the owned coin count display 34, and the acquired star count display 33 are hidden in each player indicator. In addition, at this time, the number of coins owned at the start of the competitive mini-game is displayed at the owned coin count display 34 of each player indicator (see FIG. 8). Then, each character is placed on a platform having a height corresponding to this number of owned coins.

Next, as shown in FIG. 14, the number of coins acquired in the competitive mini-game is reflected in the owned coin count display 34 of the player indicator, and the height of the platform described above is updated. In addition, at this time, the owned coin ranking display 36 is additionally displayed in each player indicator. In FIG. 14, the character B has won the competition and acquired 34 coins, and the number of coins owned by the character B is the largest. Since, as described above, when the results of the competitive mini-game are announced, the player indicators 21 to 24 are displayed in the lower part of the screen so as to be aligned in the order of arrival of turns after the end of the competitive mini-game, the attention of each player can be naturally drawn to the game development after the end of the competitive mini-game.

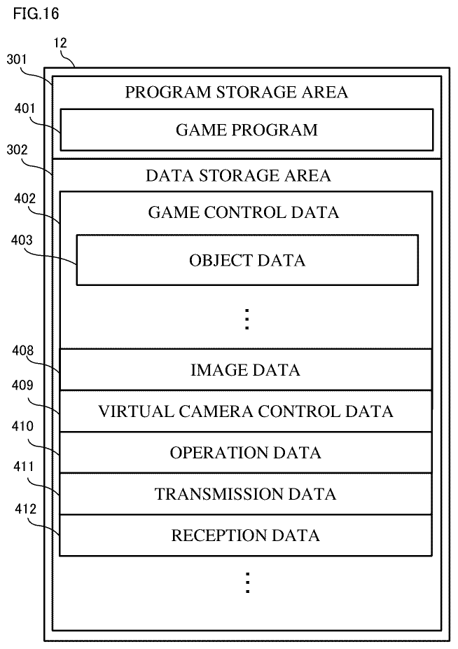

Next, the start of a time sale, which is a type of event, will be described. FIG. 15 illustrates a turn for the start of the time sale. As shown in FIG. 15, when the turn for the start of the time sale is executed, the event indicator 26 indicating the start of the time sale is displayed at the left end of the turn display UI in an enlarged manner for a relatively short time (e.g., 0.5 seconds), and a display 66 indicating “Time sale starts” is displayed. This indicates that the time sale has started. In addition, as shown in FIG. 15, an event indicator 27 indicating the turn for the end of the time sale is displayed next to the player indicator 24, and the event indicator 25 indicating the turn for the competitive mini-game to be executed last in the round is displayed next to the event indicator 27. In the turn for the end of the time sale, the event indicator 27 indicating the end of the time sale is displayed at the left end of the turn display UI in an enlarged manner for a relatively short time (e.g., 0.5 seconds), and a display indicating “Time sale ends” is displayed (not shown). As already described, during the time sale, for example, if a character stops at a square where an item can be purchased with coins, this character can purchase the item with fewer coins than usual.

### Details of Information Processing of Exemplary Embodiment

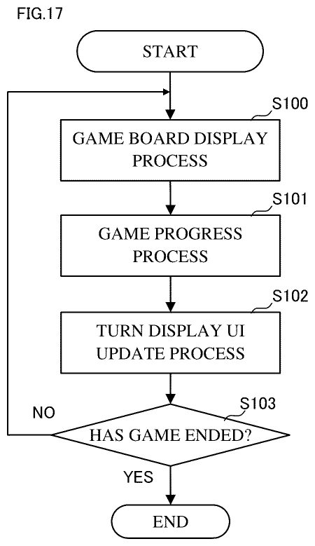

Next, the information processing of the exemplary embodiment will be described in detail with reference to FIG. 16 and FIG. 17.

### Data to be Used

Various types of data to be used in the game processing will be described. FIG. 16 shows an example of data stored in the storage section 12 of the game apparatus 1. As shown in FIG. 16, the storage section 12 is provided with at least a program storage area 301 and a data storage area 302. A game program 401 is stored in the program storage area 301. In the data storage area 302, game control data 402, image data 408, virtual camera control data 409, operation data 410, transmission data 411, reception data 412, etc., are stored. The game control data 402 includes object data 403.

The game program 401 is a game program for executing the game processing.

The object data 403 is data of objects to be placed in the virtual space, such as player characters, enemy characters that appear in mini-games, etc., items, boards, and the components (player indicators, event indicators) of the turn display UI. In addition, the object data 403 includes data of the coordinates (position), the orientation, the posture, the state, etc., of each object.

The image data 408 is image data of backgrounds, virtual effects, etc.

The virtual camera control data 409 is data for controlling the motion of the virtual camera placed in the virtual space.

The operation data 410 is operation data indicating the contents of operations performed on the controller 3.

The transmission data 411 is data to be transmitted to other game apparatuses 1.

The reception data 412 is transmission data received from other game apparatuses 1.

In addition, various types of data to be used in game processing are stored as necessary in the storage section 12.

### Game Processing

Next, the game processing according to the exemplary embodiment will be described with reference to a flowchart. FIG. 17 is an example of a flowchart showing the details of the game processing according to the exemplary embodiment. In the following, the processing characteristic of the exemplary embodiment will be mainly described, and the description of other processing such as rendering of game images is omitted. The game processing is executed at a predetermined cycle (for example, a frame cycle).

When the game processing is started and the game is started, the game processing in FIG. 17 is started.

First, in step S100, the processor 11 performs a game board display process. Specifically, if the processor 11 determines that the player who is currently taking their turn has performed an operation for displaying the game board on the basis of the operation data 410 (or the reception data 412), the processor 11 displays the game board on the display unit (see FIG. 2). In addition, if the processor 11 determines that the player who is currently taking their turn has performed an operation for ending the display of the game board on the basis of the operation data 410 (or the reception data 412), the processor 11 ends the display of the game board. Then, the processing shifts to step S101.

In step S101, the processor 11 performs a game progress process. Specifically, the processor 11 causes the game to progress by executing turns in each of which a character rolls the die and moves forward, etc. (see FIG. 3 to FIG. 7) and turns for events (see FIG. 8 to FIG. 15) in order. In addition, the processor 11 displays the turn display UI in the lower part of the screen. Then, the processing shifts to step S102.

In step S102, the processor 11 performs a turn display UI update process. Specifically, as described with reference to FIG. 3 to FIG. 9 and FIG. 13 to FIG. 15, the processor 11 aligns and displays the player indicators and the event indicators in the order of arrival of turns, in the turn display UI displayed in the lower part of the screen, and moves the player indicators and the event indicators, etc., in accordance with the progress of the turns, etc. In addition, as described with reference to FIG. 10 to FIG. 12, the processor 11 moves the player indicators to the positions for each team in the competitive mini-game. Then, the processing shifts to step S103.

In step S103, the processor 11 determines whether or not the game has ended. Specifically, the processor 11 determines whether or not an ending condition for this game (e.g., a condition that 10 rounds have ended and ending has been executed) has been satisfied. If the result of this determination is YES, the processing ends, and, if the result of this determination is NO, the processing returns to step S100.

As described above, in the exemplary embodiment, in a game scene, the turn display UI, in which the player indicator of each player and the event indicators are aligned in the order of arrival of turns and which is updated in accordance with the progress of the turns, etc., is displayed (see FIG. 3 to FIG. 8 and FIG. 13 to FIG. 15). Owing to this, in the exemplary embodiment, not only the player who is currently taking their turn but also the players who are not currently taking their turn can play while recognizing at a glance the order of arrival of the turns of the opponent players and the event turns in each game scene, so that this game can be played more strategically. Also, in the exemplary embodiment, since the turn display UI is also displayed in the display screen of the game board (see FIG. 2), this game can be played more strategically in consideration of the positional relationship between each character. In addition, in the exemplary embodiment, since the turn display UI is displayed when the competitive mini-game is started and when the results thereof are announced (see FIG. 9, FIG. 13, and FIG. 14), each player can play while recognizing at a glance the order of arrival of the turns of the opponent players and the event turns after the end of the competitive mini-game, so that this game can be played more strategically.

### Modifications

In the above exemplary embodiment, the example in which the player indicator corresponding to the player currently taking their own turn is displayed at the left end of the lower part of the screen in the turn display UI, is shown (see FIG. 3 to FIG. 7). However, for example, in the turn display UI, instead of the player indicator corresponding to the player currently taking their own turn, the player indicator corresponding to the player of the next turn may be displayed at the left end of the lower part of the screen. In this case, for example, in FIG. 3, the turn display UI is displayed such that the player indicator 21 and the character A overlapping this indicator are not displayed and the player indicator 22 for the next turn is located at the left end of the lower part of the screen.

In the above exemplary embodiment, the example in which the turn display UI (player indicators and event indicators) is arranged at the lower part of the screen laterally from the left, is shown (see FIG. 3, etc.). However, the position and arrangement of the turn display UI are not limited thereto. For example, the turn display UI may be arranged in order from right. Alternatively, the turn display UI may be arranged vertically on the left or right side of the screen in order from the bottom or top.

In the above exemplary embodiment, each player indicator may include an image of the player corresponding to the player indicator. In this case, for example, an image of the player taken by a camera (not shown) of the game apparatus 1 at the start of this game, or the like, is set as the image of the player.

In the exemplary embodiment, a case in which a series of processes regarding the game processing are executed in a single game apparatus has been described. In another exemplary embodiment, the series of processes may be executed in an information processing system including a plurality of information processing apparatuses. For example, in an information processing system including a terminal-side apparatus and a server-side apparatus communicable with the terminal-side apparatus via a network, some of the series of processes above may be executed by the server-side apparatus. Further, in an information processing system including a terminal-side apparatus and a server-side apparatus communicable with the terminal-side apparatus via a network, major processes among the series of processes above may be executed by the server-side apparatus, and some of the processes may be executed in the terminal-side apparatus. Further, in the above information processing system, the system on the server side may be implemented by a plurality of information processing apparatuses, and processes that should be executed on the server side may be shared and executed by a plurality of information processing apparatuses. Further, a configuration of a so-called cloud gaming may be adopted. For example, a configuration may be adopted in which: the game apparatus sends operation data indicating operations performed by the user to a predetermined server; various game processes are executed in the server; and the execution result is streaming-distributed as a moving image/sound to the game apparatus.

While the exemplary embodiment and the modifications have been described, the description thereof is in all aspects illustrative and not restrictive. It is to be understood that various other modifications and variations may be made to the exemplary embodiment and the modifications.

What is claimed is:

1. A non-transitory computer-readable storage medium having stored therein a game program causing one or more processors of an information processing apparatus to,
in a multiplayer game by a plurality of players:
in each turn associated with each of the players, perform game processing, based on play by the player who is taking their turn, and cause the game to progress in accordance with an order of the turns;
update a UI, including at least a plurality of player indicators respectively corresponding to the players, in accordance with progress of the game such that the player indicator corresponding to a player of a currently played turn or a next turn is placed at a first position and the player indicators corresponding to the players whose turns arrive later are aligned in an order of arrival of turns so as to follow the first position; and
generate a game image including at least a game scene and the UI.

2. The storage medium according to claim 1, wherein the game program further causes the one or more processors to cause the game to progress by repeating a round including a plurality of turns in a predetermined order and including at least the turns of all the players.

3. The storage medium according to claim 1, wherein the game program further causes the one or more processors to:
at start of each of the turns of the players,
place the player indicator corresponding to the player whose turn has started, at the first position, and
place a player character controlled in a virtual space based on play by said player, at a position in the virtual space, said position being associated with the first position in the game image; and
control the play based on play by the player whose turn has started.

4. The storage medium according to claim 2, wherein
the turns included in the round further include a turn in which an in-game event of the game occurs, in addition to the turns of the players,
the UI further includes an event indicator indicating the in-game event, in addition to the plurality of player indicators, and
the game program further causes the one or more processors to:
execute the in-game event if the turn for the in-game event in the round arrives in the game; and
update the UI in accordance with progress of the game such that the player indicators and the event indicator corresponding to the in-game event are aligned in the order of arrival.

5. The storage medium according to claim 4, wherein
the in-game event is a mini-game event in which the plurality of players participate simultaneously, and
the game program further causes the one or more processors to,
at a first timing at start of the mini-game event:
further update the UI such that the player indicators are arranged in an order of turns of the players after the mini-game event; and
place player characters respectively controlled in a virtual space based on play by the players, at positions in the virtual space, said positions being respectively associated with positions of the player indicators in the game image.

6. The storage medium according to claim 5, wherein
the mini-game event is a competitive mini-game event in which the plurality of players are divided into a plurality of teams and compete against each other, and
the game program further causes the one or more processors to,
at a second timing at the start of the mini-game event and after the first timing:
further update the UI such that the player indicators are placed for each team; and
further move each of the player characters to a position in the virtual space, said position being associated with an updated position of the player indicator.

7. The storage medium according to claim 5, wherein the game program further causes the one or more processors to,
at a third timing at the start of the mini-game event and before the first timing,
further update the UI such that the event indicator is placed at the first position and the player indicators are arranged in the order of turns of the players after the mini-game event.

8. The storage medium according to claim 5, wherein the game program further causes the one or more processors to,
at a fourth timing at which a result of the mini-game event is displayed after end of the mini-game event:
further update the UI such that the player indicators are arranged in the order of turns of the players after the mini-game event; and
place each of the player characters at a position in the virtual space, said position being associated with a position of the player indicator.

9. The storage medium according to claim 1, wherein the player indicators further include information regarding scores of the respective players in the game.

10. The storage medium according to claim 1, wherein the player indicators further include images of player characters controlled based on play by the respective players in the game.

11. The storage medium according to claim 1, wherein the player indicators further include images of the respective players.

12. The storage medium according to claim 1, wherein the player indicators further include names assigned to the respective players.

13. A game apparatus comprising one or more processors, the one or more processors being configured to,
in a multiplayer game by a plurality of players:
in each turn associated with each of the players, perform game processing, based on play by the player who is taking their turn, and cause the game to progress in accordance with an order of the turns;
update a UI, including at least a plurality of player indicators respectively corresponding to the players, in accordance with progress of the game such that the player indicator corresponding to a player of a currently played turn or a next turn is placed at a first position and the player indicators corresponding to the players whose turns arrive later are aligned in an order of arrival of turns so as to follow the first position; and
generate a game image including at least a game scene and the UI.

14. The game apparatus according to claim 13, wherein the one or more processors are further configured to cause the game to progress by repeating a round including a plurality of turns in a predetermined order and including at least the turns of all the players.

15. The game apparatus according to claim 13, wherein the one or more processors are further configured to:
at start of each of the turns of the players,
place the player indicator corresponding to the player whose turn has started, at the first position, and
place a player character controlled in a virtual space based on play by said player, at a position in the virtual space, said position being associated with the first position in the game image; and
control the play based on play by the player whose turn has started.

16. The game apparatus according to claim 14, wherein
the turns included in the round further include a turn in which an in-game event of the game occurs, in addition to the turns of the players,
the UI further includes an event indicator indicating the in-game event, in addition to the plurality of player indicators, and
the one or more processors are further configured to:
execute the in-game event if the turn for the in-game event in the round arrives in the game; and
update the UI in accordance with progress of the game such that the player indicators and the event indicator corresponding to the in-game event are aligned in the order of arrival.

17. The game apparatus according to claim 16, wherein
the in-game event is a mini-game event in which the plurality of players participate simultaneously, and
the one or more processors are further configured to,
at a first timing at start of the mini-game event:
further update the UI such that the player indicators are arranged in an order of turns of the players after the mini-game event; and
place player characters respectively controlled in a virtual space based on play by the players, at positions in the virtual space, said positions being respectively associated with positions of the player indicators in the game image.

18. A game processing method executed by one or more processors of an information processing apparatus, the game processing method causing the one or more processors to,
in a multiplayer game by a plurality of players:
in each turn associated with each of the players, perform game processing, based on play by the player who is taking their turn, and cause the game to progress in accordance with an order of the turns;
update a UI, including at least a plurality of player indicators respectively corresponding to the players, in accordance with progress of the game such that the player indicator corresponding to a player of a currently played turn or a next turn is placed at a first position and the player indicators corresponding to the players whose turns arrive later are aligned in an order of arrival of turns so as to follow the first position; and
generate a game image including at least a game scene and the UI.

19. The game processing method according to claim 18, further causing the one or more processors to cause the game to progress by repeating a round including a plurality of turns in a predetermined order and including at least the turns of all the players.

20. The game processing method according to claim 18, further causing the one or more processors to:
at start of each of the turns of the players,
place the player indicator corresponding to the player whose turn has started, at the first position, and
place a player character controlled in a virtual space based on play by said player, at a position in the virtual space, said position being associated with the first position in the game image; and
control the play based on play by the player whose turn has started.

21. The game processing method according to claim 19, wherein the turns included in the round further include a turn in which an in-game event of the game occurs, in addition to the turns of the players,
the UI further includes an event indicator indicating the in-game event, in addition to the plurality of player indicators, and
the game processing method further causes the one or more processors to:
execute the in-game event if the turn for the in-game event in the round arrives in the game; and
update the UI in accordance with progress of the game such that the player indicators and the event indicator corresponding to the in-game event are aligned in the order of arrival.

22. The game processing method according to claim 21, wherein the in-game event is a mini-game event in which the plurality of players participate simultaneously, and
the game processing method further causes the one or more processors to,
at a first timing at start of the mini-game event:
further update the UI such that the player indicators are arranged in an order of turns of the players after the mini-game event; and
place player characters respectively controlled in a virtual space based on play by the players, at positions in the virtual space, said positions being respectively associated with positions of the player indicators in the game image.
